(19) United States
(12) Patent Application Publication
(10) Pub. No.: US 2012/0237641 A1
(43) Pub. Date: Sep. 20, 2012

(54) PET FOOD COATING FOR REDUCING DENTAL CALCULUS ACCUMULATION IN DOMESTIC ANIMALS

(76) Inventors: Tiandong Jia, Bound Brook, NJ (US); Melinda Fernyhough Culver, Oakland, CA (US); Marta Draper, Nyack, NY (US)

(21) Appl. No.: 13/419,993

(22) Filed: Mar. 14, 2012

Related U.S. Application Data
(60) Provisional application No. 61/452,818, filed on Mar. 15, 2011.

(51) Int. Cl. A23L 3/3454; A23K 1/00; A23P 1/08

(52) U.S. Cl. 426/89; 426/532; 426/335; 426/310

(57) ABSTRACT

An improved pet food product, such as a dog biscuit or other treat, is provided. The pet food product is formed with a coating which includes a polyphosphate as a sequestering agent in an amount of between about 0.5 and 3.0 percent weight as compared to the overall weight of the food product and a non-ionic antimicrobial agent containing from between 10 and 40 percent weight of fat with the remainder being a carrier. The antimicrobial agent is present in an amount between about 0.15 and 2.0 percent weight as compared to the overall weight of the food product.

This application is based on and claims priority of U.S. Provisional Patent application Ser. No. 61/452,818, filed Mar. 15, 2011.

### BACKGROUND OF THE INVENTION

It is well known in the field of dentistry that dental calculus is formed by the calcification of dental plaque. The term “dental plaque” refers to the community of microorganisms found on a tooth surface as a biofilm; it is embedded in a matrix of polymers of host and bacterial origin. As described in various current medical journals, the biofilm character of plaque allows for the survival both of less acid-tolerant organisms in addition to acid-tolerant microorganisms. It also allows for the coexistence of aerobic and anaerobic bacteria.

Sodium hexametaphosphate (SHMP) is a known sequestering agent which can prevent dental calculus when applied as a coating to pet food or treats. A sequestering agent such as SHMP can form complex compounds with calcium ions that are in saliva, making these calcium ions less available to form dental calculus. The higher the concentration of SHMP within a coating that is applied to a dental food or treat, the better the effect in preventing calculus accumulation. However, as the concentration of SHMP in the food or treat increases so does the bitterness of the food or treat to the taste, and, therefore, the organoleptic acceptance is lower. As a result, palatants are generally then added to a food or treat coating that includes SHMP in order to offset the negative effect of using a high concentration of SHMP in the coating.

It is also known that antimicrobial agents can reduce plaque formation, which, in turn, reduces calculus formation. In accordance with the invention, when SHMP is combined with a particular category of non-ionic antimicrobial agents in a coating for pet food and treats, a synergistic effect in reducing dental calculus is achieved.

The current invention is thus novel in that it improves upon pet food and treat products that are intended for reducing dental calculus in domestic animals, particularly dogs.

### SUMMARY OF THE INVENTION

Generally speaking, in accordance with the invention, an improved pet food product, such as a dog biscuit or other treat, is provided. The pet food product is formed with a coating which includes a polyphosphate as a sequestering agent in an amount of between about 0.5 and 3.0 percent weight as compared to the overall weight of the food product and a non-ionic antimicrobial agent containing from between 10 and 40 percent weight of fat with the remainder being a carrier; the antimicrobial agent is present in an amount between about 0.15 and 2.0 percent weight as compared to the overall weight of the food product.

The polyphosphates that can be used in the inventive coating include SHMP, tetrasodium pyrophosphate (TSPP), sodium tripolyphosphate (STPP) and sodium acid pyrophosphate (SAPP).

The fat of the non-ionic antimicrobial agent is formed from chains of fatty acids selected from the group consisting of lauric acid, myristic acid, capric acid, myristoleic acid, palmitic acid, palmitoleic acid and linoleic acid. The preferred fatty acids are myristic acid and palmitic acid. The coating is applied to the pet food product by spraying under heated conditions.

Accordingly, it is an object of the invention to provide an improved pet food product.

Another object of the invention is to provide a pet food product for reducing dental calculus accumulation.

A further object of the invention is to provide a pet food product which a pet is desirous of eating.

Still other objects and advantages will be apparent from the following description.

### DETAILED DESCRIPTION OF THE INVENTION

In accordance with the invention, a pet food product, such as a dog biscuit or other treat, is provided. The pet food product is formed with a coating which includes a polyphosphate as a sequestering agent preferably in an amount of between about 0.5 and 3.0 percent weight as compared to the overall weight of the food product and a non-ionic antimicrobial agent containing from between 10 and 40 percent weight of fat with the remainder being a carrier. The antimicrobial agent is preferably present in an amount between about 0.15 and 2.0 percent weight as compared to the overall weight of the food product.

The preferred polyphosphate is SHMP. Other suitable polyphosphates include tetrasodium pyrophosphate (TSPP), sodium tripolyphosphate (STPP) and sodium acid pyrophosphate (SAPP).

The fat of the non-ionic antimicrobial agent is formed from chains of fatty acids. The fatty acids may be selected from the group consisting of lauric acid, myristic acid, capric acid, myristoleic acid, palmitic acid, palmitoleic acid and linoleic acid. The preferred fatty acids are myristic acid and palmitic acid.

The carrier of the non-ionic microbial agent can be selected from maltodextrin, corn starch, wheat flour, gum acacia, and modified starch.

The inventive coating is prepared by adding the polyphosphate to the antimicrobial agent along with water in order to form a liquid emulsion.

The non-ionic antimicrobial agent is preferably formed by spray drying encapsulation of the fat into the carrier in order to form a free flowing powder. Alternatively, the fat and carrier are mixed together in order to form an emulsion.

The preferred non-ionic antimicrobial agent is a palatability product sold under the name SAVORGUARD by Flavors International, LLC located in New Brunswick, N.J.

The inventive coating is preferably applied to the pet food product by means of spraying.

In its preferred form, the inventive coating contains polyphosphate in an amount between about 10 and 40 percent weight and non-ionic antimicrobial agent in an amount between about 2 and 8 percent weight, with the balance being water in an amount between about 30 and 80 percent weight.

Flavoring such as meat digest may also be included in the inventive coating in an amount between about 5 and 50 percent weight.

The pet food product itself is typically made from grain, meat, dairy materials, colorant, flavors, vitamins and minerals.

A preferred formulation for the inventive food product treat is as follows:

| Ingredients | % Wt |
|---|---|
| WheatFlour | 36.00% |
| Wheat | 35.00% |
| Poultry Meal | 15.00% |
| SHMP | 2.00% |
| Wheat Germ Meal | 3.00% |
| Caramel color | 2.50% |
| Poultry Fat | 2.00% |
| Salt | 0.60% |
| Whey, Dried | 0.30% |
| Barley Fl, Malt | 0.30% |
| Molasses Cane | 0.30% |
| Calcium Carbonate | 0.30% |
| Flavors | 1.00% |
| Yeast, Brewers | 0.81% |
| Antimicrobial agent (SAVORGUARD) | 0.50% |
| Citric Acid | 0.20% |
| Choline Chloride | 0.10% |
| Vitamin/Mineral Premix | 0.09% |
| | 100.00% |

A preferred formulation for the inventive coating is as follows:

| Ingredients | Typical |
|---|---|
| Water | 61.5% |
| SHMP | 24.0% |
| Other Flavors | 8.5% |
| Non-ionic antimicrobial | 6.0% |
| agent (SAVORGUARD) | |

The use of a particular category of antimicrobial agents in combination with SHMP, or some other polyphosphates, for pet food products is advantageous. The antimicrobial agent of the inventive coating enhances the palatability of SHMP coated dental treats.

The particular category of antimicrobial agents of the inventive pet food coating unexpectedly enhances the palatability of an SHMP coated treat. In contrast, other known tested common palatants (such as chicken digest flavor) do not contain antimicrobial properties. Other antimicrobial agents, such as zinc (ion) salt, do not enhance palatability for an SHMP coated pet food product/treat.

In this regard, it has been found to be counterproductive to combine a zinc (ion) salt with SHMP in a food or treat coating because SHMP chelates with a zinc ion and reduces the availability of SHMP for chelating calcium. It is noted that zinc ions and calcium ions have similar properties in that both form a complex with SHMP. However, because there is a limited amount of SHMP that is available to form a complex, when a zinc ion is added to a pet food product coating, the zinc ion will immediately form a complex with SHMP. This has two unwanted effects: reducing the number of sites remaining on the SHMP molecule for salivary calcium binding and reducing the amount of zinc available to act as an antimicrobial.

Combining in a coating for a pet food, such as a treat, SHMP and the particular non-ionic antimicrobial agent identified herein is advantageous over just using SHMP in the coating, or even combining SHMP with zinc in the coating as discussed above, as shown in the table below.

In that regard, pet food products that use a high concentration only of SHMP in the coating (greater than 2% by weight in the coating), are not easily accepted by pets. In contrast, pet foods having a coating which incorporates the inventive combination of SHMP with a non-ionic antimicrobial agent are more widely accepted by pets, even if a high SHMP concentration is used in the coating, thus allowing for better calculus reduction. Importantly, a “synergistic effect” is achieved, causing a reduction in calculus accumulation.

It is noted that if ionic antimicrobial Zn²⁺ replaces the non-ionic antimicrobial agent in an SHMP coating for a pet food, the percentage of tartar reduction is lower than if SHMP is used alone. In fact, in one test, the percentage of tartar accumulation is greater than even that exhibited by the control (plain food product without any coating).

Interestingly, when both ionic and nonionic antimicrobial agents are combined with SHMP as a test mixture, the percentage of tartar reduction is lower than that of SHMP when used by itself.

| | | % tartar reduction |
|---|---|---|
| Source of data | SHMP % | vs control |
| 1.7% SHMP | 1.70% | 37.6% |
| 2.5% SHMP | 2.50% | 49.5% |
| 2.5% SHMP + non-ionic | 2.50% | 54.8% |
| antimicrobial agent | | |
| 2.5% SHMP + Zn²⁺ | 2.50% | −7.1%* |
| 2.5% SHMP + non-ionic | 2.50% | 9.5% |
| antimicrobial agent + Zn²⁺ | | |

*increased tartar accumulation.

It is noted that the testing reported in the above chart followed standardized VOHC test procedures. The testing process was as follows:

The teeth of several dogs were cleaned by a trained dental technician so that no plaque or calculus was present after cleaning. The dogs were then fed with the same amount of control biscuits or sample biscuits for 28 days. The dental scores indicated describe the amount of tartar that accumulated on the dogs' teeth. The dogs that were fed the control biscuit had a calculus score (T) of 100%; the dogs that were fed the test biscuit had dental scores of a certain amount; the difference between the two dental scores (D) represented the amount of calculus reduction for the particular test biscuit. The ratio between the amount of calculus reduction of a particular test biscuit and the dental score of the control is the percentage of the reduction (R) of calculus accumulation−R=D/T %.

The process of coating baked dog treats with the inventive combination of SHMP and an antimicrobial agent is shown in the chart below:

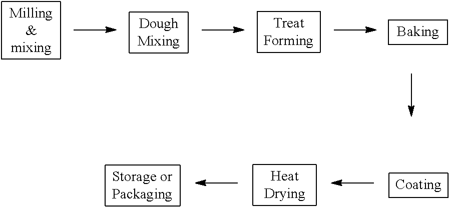

In practice, and in accordance with the invention, a dog food, such as a biscuit or other treat is coated in a spraying drum at 150° F. to 250° F. for a time period of between 45 to 90 seconds. It is then heat dried in a dryer for 30 to 75 minutes at a temperature ranging from 250° F. to 350° F., depending on the physical dimension of the food product.

In the current invention, it is advantageous to combine SHMP and the specified non-ionic antimicrobial agent as a coating for baked pet food/treats. With previously manufactured pet products that do not include SHMP in the coating, there is no dental sequestering agent. Further, when no non-ionic antimicrobial agent is added to the coating, a higher concentration of SHMP within the coating cannot be used.

As a palatant for dogs, adding the particular type of non-ionic antimicrobial agent, as discussed hereinabove, to the food or coating will make biscuits and other food products more acceptable to dogs. Without the addition of such an antimicrobial agent, when SHMP is 2% or more by weight in the coating, many dogs will not accept the SHMP biscuits; however, when such a non-ionic antimicrobial agent is added to the biscuit or other food coating along with 2% or more SHMP, most dogs will eat the biscuit

The current invention may be applied to other domestic animal/pet foods including treats in addition to those for dogs.

The scope of the invention is sent forth in the following claims.

1. A coating for a food product comprising:
a polyphosphate in an amount between about 10 and 40 weight percent;
a non-ionic antimicrobial agent in an amount between about 2 and 8 weight percent; and
the remainder being water.

2. The coating of claim 1,
wherein the antimicrobial agent contains from between about 10 and 40 weight percent of fat with the remainder of the anti-microbial agent being a carrier.

3. The coating of claim 2, wherein the fat is formed fatty acid chains selected from the group consisting of lauric acid, myristic acid, capric acid, myristoleic acid, palmitic acid, palmitoleic acid and linoleic acid.

4. The coating of claim 2, wherein the polyphospahate is selected from the group consisting of sodium hexametaphosphate, tetrasodium pyrophosphate, sodium tripolyphosphate and sodium acid pyrophosphate.

5. The coating of claim 4, wherein the polyphoshate is sodium hexametaphosphate.

6. The coating of claim 2, wherein the carrier is selected from the group consisting of maltodextrin, corn starch, wheat flour, gum acacia and modified starch.

7. The coating of claim 2, wherein water is present between about 30 and 80 weight percent.

8. The coating of claim 2, further including flavoring in an amount between about 5 and 50 weight percent.

9. The coating of claim 8, wherein said flavoring is meat digest.

10. The coating of claim 3, wherein the polyphospahate is selected from the group consisting of sodium hexametaphosphate, tetrasodium pyrophosphate, sodium tripolyphosphate and sodium acid pyrophosphate.

11. The coating of claim 10, wherein the carrier is selected from the group consisting of maltodextrin, corn starch, wheat flour, gum acacia and modified starch.

12. A method for making a dog food product, the method comprising the steps of:
(a) forming an animal food treat;
(b) applying a coating to said animal treat, said coating comprising a polyphosphate in an amount between about 10 and 40 weight percent; a non-ionic antimicrobial agent in an amount between about 2 and 8 weight percent, and the balance being water;
(c) heating said animal treat with said applied coating.

13. The method of claim 12, wherein the antimicrobial agent contains from between about 10 and 40 weight percent of fat with the remainder of the microbial agent being a carrier.

14. The method of claim 13, wherein said forming step includes the steps of mixing dough into a pre-formed treat and then baking said pre-formed treat.

15. The method of claim 13 wherein said heating step is carried out at a temperature of between about 250° F. and 350° F.

16. The method of claim 13 wherein said applying step comprises spraying said coating onto said treat at a temperature of between about 150° F. and 350° F.

17. The method of claim 13, wherein the fat is formed from fatty acid chains selected from the group consisting of lauric acid, myristic acid, capric acid, myristoleic acid, palmitic acid, palmitoleic acid and linoleic acid and the polyphospahate is selected from the group consisting of sodium Hexametaphosphate, tetrasodium pyrophosphate, sodium tripolyphosphate and sodium acid pyrophosphate.

18. A food product comprising:
an animal food treat and a coating applied to said treat, the coating comprising a 0.5 and 3.0 weight percent polyphosphate and a 0.15 and 2.0 weight percent non-ionic anti-microbial agent, the weight percents based on the overall weight of the food product;
wherein the antimicrobial agent has between 10 and 40 weight percent fat.

19. The food product of claim 16, wherein the fat is formed from fatty acid chains selected from the group consisting of lauric acid, myristic acid, capric acid, myristoleic acid, palmitic acid, palmitoleic acid and linoleic acid.

20. The food product of claim 19, wherein the polyphosphate is selected from the group consisting of sodium hexametaphosphate, tetrasodium pyrophosphate, sodium tripolyphosphate and sodium acid pyrophosphate.
